(19) United States
(12) Patent Application Publication
(10) Pub. No.: US 2024/0022957 A1
(43) Pub. Date: Jan. 18, 2024

(54) LAYER TWO PROCESSING PROCEDURES FOR PROTOCOL DATA UNIT SETS WITH DEPENDENCY

(71) Applicant: QUALCOMM Incorporated, San Diego, CA (US)

(72) Inventors: Linhai HE, San Diego, CA (US); Dario Serafino TONESI, San Diego, CA (US); Miguel GRIOT, La Jolla, CA (US); Gavin Bernard HORN, La Jolla, CA (US); Yuchul KIM, San Diego, CA (US); Huilin XU, Temecula, CA (US); Mickael MONDET, Louannec (FR); Prashanth Haridas HANDE, San Diego, CA (US)

(21) Appl. No.: 17/812,831

(22) Filed: Jul. 15, 2022

(51) Int. Cl. H04W 28/06

(52) U.S. Cl. CPC H04W 28/06

(57) ABSTRACT

Various aspects of the present disclosure generally relate to wireless communication. In some aspects, a wireless communication device may receive multiple protocol data units (PDUs) associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets. The wireless communication device may perform a layer two PDU processing procedure associated with the at least one PDU or the PDU set based at least in part on the dependency information. Numerous other aspects are described.

### FIELD OF THE DISCLOSURE

Aspects of the present disclosure generally relate to wireless communication and to techniques and apparatuses for layer two processing procedures for protocol data unit sets with dependency.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device. The method may include receiving multiple protocol data units (PDUs) associated with a PDU set, and wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets. The method may include performing a layer two PDU processing procedure associated with the at least one PDU or the PDU set based at least in part on the dependency information.

Some aspects described herein relate to a method of wireless communication performed by a wireless communication device. The method may include transmitting multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets. The method may include performing a layer two PDU processing procedure associated with the at least one PDU or the PDU set based at least in part on the dependency information.

Some aspects described herein relate to a wireless communication device for wireless communication. The wireless communication device may include a memory and one or more processors coupled to the memory. The one or more processors may be configured to receive multiple PDUs associated with a PDU set, and wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets. The one or more processors may be configured to perform a layer two PDU processing procedure associated with the at least one PDU or the PDU set based at least in part on the dependency information.

Some aspects described herein relate to a wireless communication device for wireless communication. The wireless communication device may include a memory and one or more processors coupled to the memory. The one or more processors may be configured to transmit multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets. The one or more processors may be configured to perform a layer two PDU processing procedure associated with the at least one PDU or the PDU set based at least in part on the dependency information.

Some aspects described herein relate to a non-transitory computer-readable medium that stores a set of instructions for wireless communication by a wireless communication device. The set of instructions, when executed by one or more processors of the wireless communication device, may cause the wireless communication device to receive multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets. The set of instructions, when executed by one or more processors of the wireless communication device, may cause the wireless communication device to perform a layer two PDU processing procedure associated with the at least one PDU or the PDU set based at least in part on the dependency information.

Some aspects described herein relate to a non-transitory computer-readable medium that stores a set of instructions for wireless communication by a wireless communication device. The set of instructions, when executed by one or more processors of the wireless communication device, may cause the wireless communication device to transmit multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets. The set of instructions, when executed by one or more processors of the wireless communication device, may cause the wireless communication device to perform a layer two PDU processing procedure associated with the at least one PDU or the PDU set based at least in part on the dependency information.

Some aspects described herein relate to an apparatus for wireless communication. The apparatus may include means for receiving multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets. The apparatus may include means for performing a layer two PDU processing procedure associated with the at least one PDU or the PDU set based at least in part on the dependency information.

Some aspects described herein relate to an apparatus for wireless communication. The apparatus may include means for transmitting multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets. The apparatus may include means for performing a layer two PDU processing procedure associated with the at least one PDU or the PDU set based at least in part on the dependency information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example of a protocol data unit (PDU) session for handling various quality of service flows, in accordance with the present disclosure.

FIG. 5 is a diagram of an example associated with layer two processing procedures for PDU sets with dependency, in accordance with the present disclosure.

FIG. 6 is a diagram illustrating an example process performed, for example, by a wireless communication device, in accordance with the present disclosure.

FIG. 7 is a diagram illustrating an example process performed, for example, by a wireless communication device, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

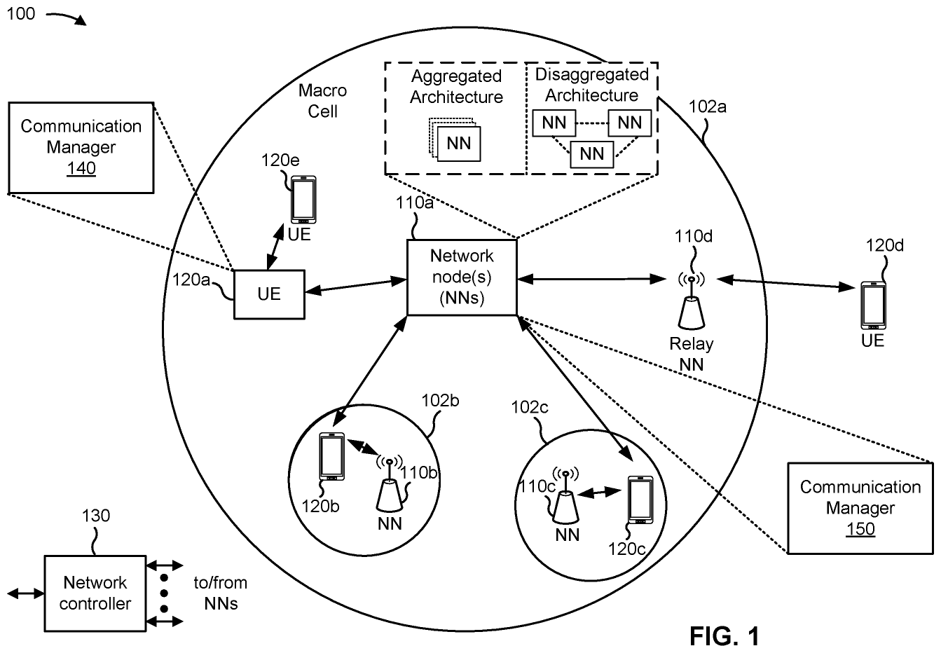

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive multiple protocol data units (PDUs) associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and perform a layer two PDU processing procedure associated with the at least one PDU or the PDU set based at least in part on the dependency information. Additionally, or alternatively, as described in more detail elsewhere herein, the communication manager 140 may transmit multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and perform a layer two PDU processing procedure associated with the at least one PDU or the PDU set based at least in part on the dependency information. Additionally, or alternatively, the communication manager 140 may perform one or more other operations described herein.

In some aspects, the network node 110 may include a communication manager 150. As described in more detail elsewhere herein, the communication manager 150 may receive multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and perform a layer two PDU processing procedure associated with the at least one PDU or the PDU set based at least in part on the dependency information. Additionally, or alternatively, as described in more detail elsewhere herein, the communication manager 150 may transmit multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and perform a layer two PDU processing procedure associated with the at least one PDU or the PDU set based at least in part on the dependency information. Additionally, or alternatively, the communication manager 150 may perform one or more other operations described herein.

As indicated above, FIG. 1 is provided as an example. Other examples may differ from what is described with regard to FIG. 1.

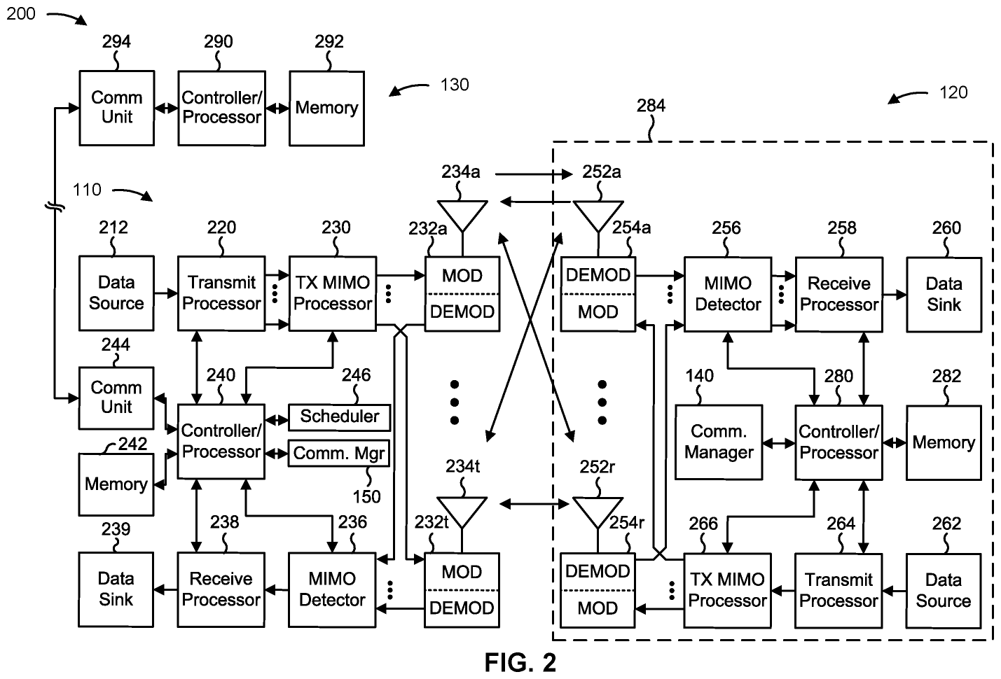

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

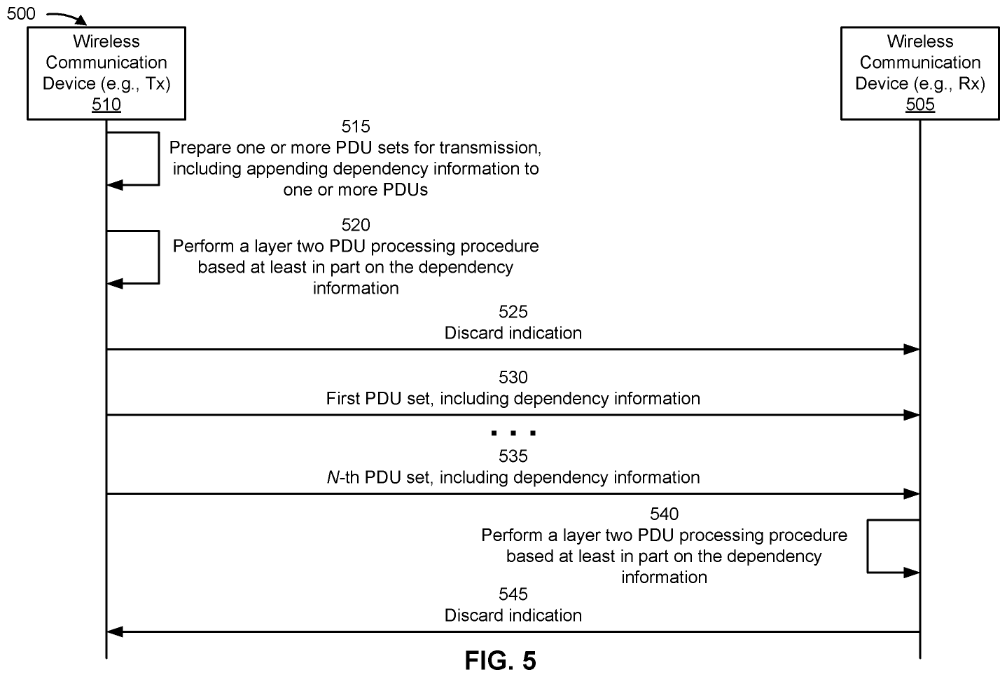

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

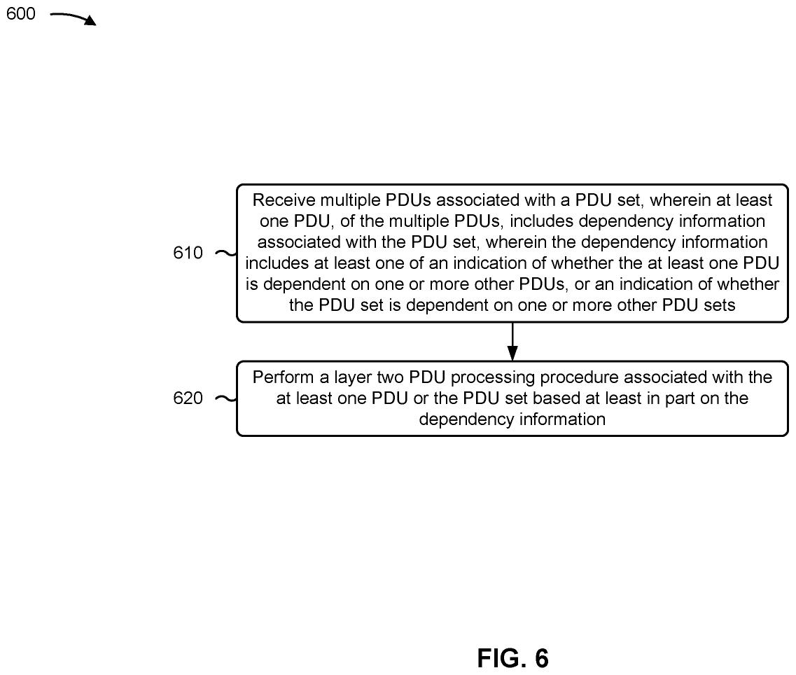

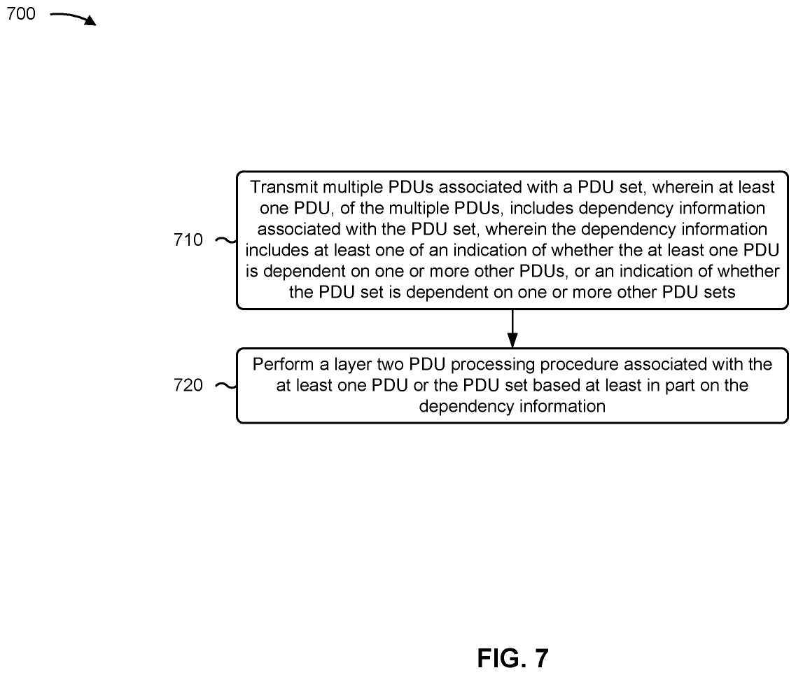

The controller/processor 240 of the network node 110, the controller/processor 280 of the UE 120, and/or any other component(s) of FIG. 2 may perform one or more techniques associated with layer two processing procedures for protocol data unit sets with dependency, as described in more detail elsewhere herein. In some aspects, the wireless communication device described herein is the UE 120 and/or the network node 110, is included in the UE 120 and/or the network node 110, or includes one or more components of the UE 120 and/or network node 110 shown in FIG. 2. The controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and/or means for performing a layer two PDU processing procedure associated with the at least one PDU or the PDU set based at least in part on the dependency information. In some aspects, the UE 120 includes means for transmitting multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and/or means for performing a layer two PDU processing procedure associated with the at least one PDU or the PDU set based at least in part on the dependency information. In some aspects, the means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and/or means for performing a layer two PDU processing procedure associated with the at least one PDU or the PDU set based at least in part on the dependency information. In some aspects, the network node 110 includes means for transmitting multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and/or means for performing a layer two PDU processing procedure associated with the at least one PDU or the PDU set based at least in part on the dependency information. In some aspects, the means for the wireless communication device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

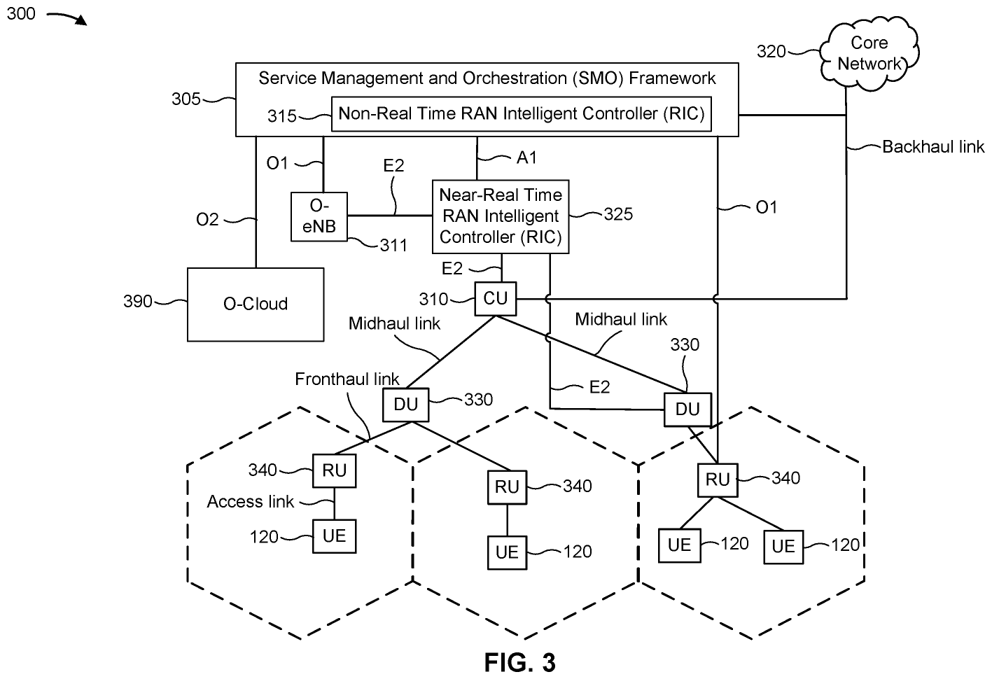

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT MC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

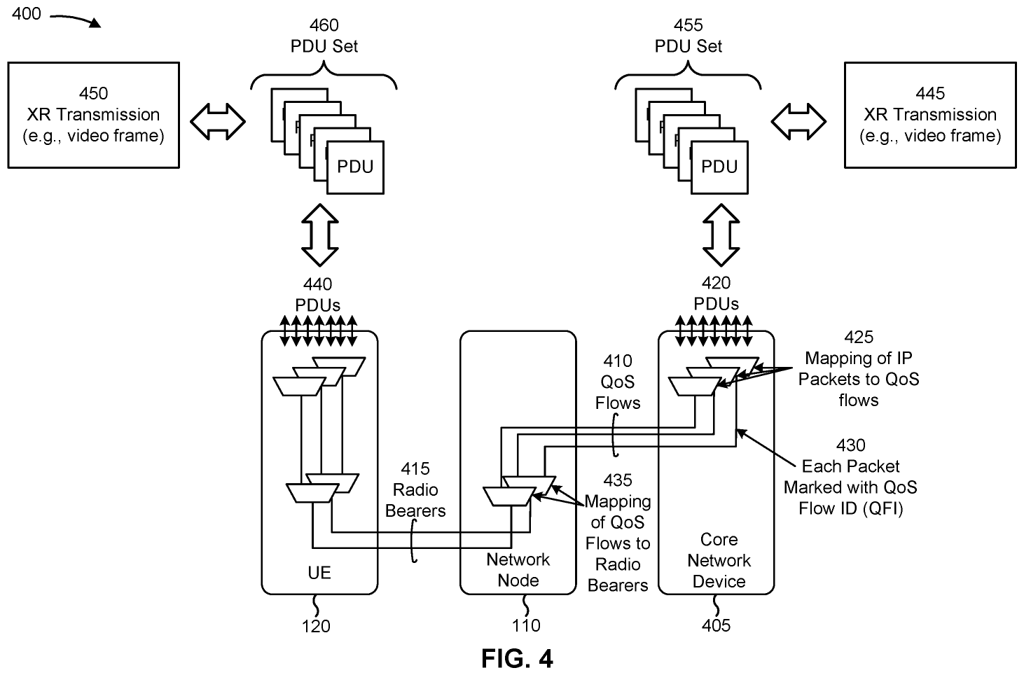

FIG. 4 is a diagram illustrating an example 400 of a PDU session for handling various quality of service (QoS) flows, in accordance with the present disclosure. As shown in FIG. 4, a UE 120, a network node 110, and a core network device 405 (e.g., a user plane function (UPF) of the core network) may communicate with each other using one or more QoS flows 410 and one or more radio bearers 415. Although shown as an integral unit for ease of description, in some aspects (e.g., in aspects implementing an architecture), the network node 110 may be disaggregated, as described in connection with FIG. 3.

The example PDU session shown in FIG. 4 may be established when the UE 120 connects to a wireless network (e.g., the wireless network 100) via the network node 110. The PDU session may be established for purposes of handling multiple QoS flows, with all traffic within a given QoS flow receiving the same forwarding treatment. For example, time-sensitive communications may be associated with a relatively high QoS priority, and thus may be mapped to a QoS flow associated with a relatively low packet delay budget (PDB) or similar QoS parameters such that the communications are forwarded largely uninterrupted. Other communications, however, which are not as time sensitive, may be associated with a relatively low QoS priority, and thus may be mapped to a QoS flow having a relatively high PDB and similar QoS parameters.

As shown by reference number 420, data packets (sometimes referred to as PDUs) may be received at the core network device 405. As shown by reference number 425, the core network device 405 may map the PDUs to one of multiple QoS flows 410 according to a QoS priority or the like. The core network device 405 may map the PDUs to the QoS flows according to certain QoS requirements, such as maximum permissible delay, required data rate, or similar requirements. For example, the most time-sensitive PDUs may be mapped to a first QoS flow 410 that is associated with a relatively low PDB, a relatively high data rate, or a similar parameter; PDUs that are less time-sensitive may be mapped to a second QoS flow 410 that is associated with a greater PDB and/or a lower data rate or similar parameter; PDUs that are even less time-sensitive may be mapped to a third QoS flow 410 that is associated with an even greater PDB and/or an even lower data rate or similar parameter, and so forth. As shown by reference number 430, each PDU may also be marked with a QoS flow identifier (QFI, sometimes referred to as a 5QI value) associated with the corresponding QoS flow 410 to assist QoS handling by the network node 110, the UE 102, and/or other network components.

As shown at reference number 435, the network node 110 may receive the PDUs via the various QoS flows 410 and map each PDU to a corresponding radio bearer 415, which may be a signaling radio bearer (SRB) or a data radio bearer (DRB). In some aspects, more than one QoS flow 410 may be mapped to a single radio bearer 415. That is, there may not be a one-to-one correlation between the QoS flows 410 and the radio bearers 415. The UE 120 receives the PDUs via the radio bearers 415.

In the uplink (e.g., when sending a transmission from the UE 120 to the network node 110 and ultimately to the core network device 405), the above process is generally performed in reverse. More particularly, as shown by reference number 440, the UE 120 may map PDUs to be transmitted to QoS flows 410 and/or radio bearers 415. In some aspects, the UE 120 may determine which QoS flow and/or radio bearer to use based at least in part on observing the various QFIs in downlink PDUs for the PDU session, which provides the UE 120 with information about which PDUs should be mapped to particular QoS flows and/or radio bearers. In some other aspects, the UE 120 may receive a configuration from the network indicating which QoS flow and/or radio bearer to use for certain PDU types, which may be received via RRC signaling or the like. The PDUs are then transmitted to the network node 110 via the radio bearers 415, and to the core network device 405 via the QoS flows 410, generally in reverse to the process described above.

In some cases, an uplink or a downlink communication may associated with multiple PDUs. For example, an extended reality (XR) related transmission (such as XR transmissions 445 and 450) may be associated with a data unit, sometimes referred to as an application data unit (ADU) and/or a PDU set, that is larger than an internet protocol (IP) packet size. Thus, as shown by the PDU sets 455 and 460, the ADU and/or the PDU set may be segmented into IP packets (e.g., PDUs) for transmission in the uplink or downlink. More particularly, in the downlink, the XR transmission 445 may be segmented into the multiple PDUs associated with the PDU set 455, with each PDU then proceeding through the core network device 405, the network node 110, and the UE 120 in a manner as described above. The PDUs may arrive at the UE 120 close in time, although there may be jitters between the PDUs. After receiving the PDUs, the UE 120 may reconstruct the PDU set and ultimately the XR transmission, sometimes by performing a video decompression process or the like. Similarly, in the uplink, the XR transmission 450 may be segmented into the multiple PDUs associated with the PDU set 460, with each PDU then proceeding through the UE 120, the network node 110, and the core network device 405 in a similar manner as described above.

PDUs associated with a PDU set have the same QoS requirements and thus may be transmitted using the same QoS flows 410. Moreover, each PDU set (e.g., PDU sets 455, 460) may be configured as a Type A PDU set or a Type B PDU set. A Type A PDU set is an all-or-nothing PDU set, meaning all PDUs of the PDU set must be safely received at a receiver in order for the PDU set to be considered safely received (e.g., if a receiver does not safely receive all the PDUs associated with the PDU set, any safely received packets are deemed useless and/or are discarded). A Type B PDU set may be a PDU set that is associated with a certain decoding criteria to be considered safely received. For example, a Type B PDU set may be associated with a certain percentage of successfully received PDUs to be considered successfully received, a target number of received bytes to be considered successfully received, or a similar decoding criterion to be considered successfully received. In this way, a Type B PDU sets may be associated with a forward error correction scheme or the like such that the PDU set may be successfully decoded (and thus considered safely received) even when less than all PDUs of the PDU set have been safely received.

In some examples, a PDU set (e.g., PDU set 455 or 460) may be dependent on another PDU set. For example, each frame associated with a group of pictures (GOP) video compression process may be associated with a PDU set, with certain frames (and thus certain PDU sets) being dependent on other frames (and thus other PDU sets) for decompression. More particularly, a video compression process may be associated with different types of video frames, such as an intra-coded frame (I-frame), a predicted frame (P-frame), or a bidirectional predicted frame (B-frame). An I-frame is the least compressible of the frame types and is independently encoded and decoded. Thus, a PDU set associated with an I-frame may not be dependent on other PDU sets. However, a P-frame or a B-frame are more compressible than I-frames and use data from other frames during a decompression process. That is, a P-frame or a B-frame may depend on one or more other frames for encoding and/or decoding, and thus a PDU set associated with a P-frame or a B-frame may depend on one or more other PDU sets (e.g., one or more other PDU sets carrying another I-frame, P-frame, or B-frame).

Moreover, in some cases, two or more PDU sets may be associated with a coupled flow and/or a coupled delay deadline, and thus may be dependent on each other. A coupled flow refers to a set of data flows that should arrive at a receiver at the same time due to a dependency of the data flows on each other. For example, video and audio streams in the same frame need to arrive at a receiver at the same time to ensure the best user experience. Thus, a video stream and an audio stream may be transmitted as a coupled flow, meaning that the flows should arrive at the receiver near the same time such that the audio and video align at the receiver. Thus, a PDU associated with a coupled flow may be dependent on another PDU in the coupled flow (e.g., an audio PDU may be dependent on a video PDU), because if certain PDUs are not safely received (e.g., PDUs associated with a video stream), other PDUs (e.g., PDUs associated with the audio stream) become obsolete, even if safely received.

Although certain PDU sets and/or PDUs may be dependent on other PDU sets and/or PDUs, this dependency may be transparent to higher protocol layers (e.g., layer two) at a receiving wireless communication device. Accordingly, a wireless communication device may perform higher layer processing (e.g., a layer two PDU processing procedure, or the like) associated with a certain PDU and/or a certain PDU set that has become obsolete or unusable because a PDU and/or PDU set from which the certain PDU and/or the certain PDU set is dependent on was not safely received. For example, if a PDU set including an I-frame is not successfully received, PDU sets including dependent P-frames and/or B-frames may be obsolete, yet the receiver may continue to perform layer two processing of any received P-frames and/or B-frames. Similarly, if a PDU associated with a coupled flow is not safely received (such as a PDU associated with a video stream of a coupled flow), other PDUs may be obsolete (such as a PDU associated with an audio stream of the coupled flow), yet the receiver may continue to perform layer two processing of the other PDUs as they are received. This may result in high power, network, and computing resource consumption associated with layer two processing of obsolete PDU sets and/or PDUs.

Some techniques and apparatuses described herein enable enhanced layer two processing of PDUs and/or PDU sets that are dependent on other PDUs and/or PDU sets. In some aspects, a PDU associated with a PDU set may indicate dependency information associated with the PDU and/or the PDU set. For example, the dependency information may indicate whether the PDU is dependent on one or more other PDUs, and/or whether the PDU set is dependent on one or more other PDU sets. A receiving wireless communication device may perform a layer two PDU processing procedure of the PDU and/or the PDU set based at least in part on the dependency information. For example, the receiving wireless communication device may discard a certain PDU and/or a certain PDU set when another PDU and/or PDU set from which the certain PDU and/or PDU set depends has not been safely received. As a result, the receiving wireless communication device may reduce power, network, and computing resource consumption associated with layer two processing of obsolete and/or unusable PDU sets and/or PDUs.

As indicated above, FIG. 4 is provided as an example. Other examples may differ from what is described with regard to FIG. 4.

FIG. 5 is a diagram of an example 500 associated with layer two processing procedures for PDU sets with dependency, in accordance with the present disclosure. As shown in FIG. 5, a first wireless communication device 505 (e.g., a network node 110, a UE 120, or a similar wireless communication device) may communicate with a second wireless communication device 510 (e.g., a network node 110, a UE 120, or a similar wireless communication device). In some aspects, the first wireless communication device 505 and the second wireless communication device 510 may be part of a wireless network (e.g., wireless network 100). The first wireless communication device 505 and the second wireless communication device 510 may have established a wireless connection prior to operations shown in FIG. 5.

In some aspects, the first wireless communication device 505 and the second wireless communication device 510 may be configured to transmit and receive PDUs as part of a wireless communication process. For example, in the aspect shown in FIG. 5, the first wireless communication device 505 may be a receiver device (indicated by “Rx” in FIG. 5), and the second wireless communication device 510 may be a transmitter device (indicated by “Tx” in FIG. 5). However, in some other aspects, the first wireless communication device 505 may transmit wireless communications to the second wireless communication device 510. Thus, in such aspects, the first wireless communication device 505 may be considered a transmitter device, and the second wireless communication device 510 may be considered a receiver device.

As shown by reference number 515, the second wireless communication device 510 (e.g., the transmitter device) may prepare one or more PDU sets for transmission to one or more other wireless communication devices, such as to the first wireless communication device 505. In some aspects, preparing one or more PDU sets for transmission may include segmenting an XR communication (e.g., XR transmission 445 or 450) into multiple PDUs associated with a PDU set, as described in connection with the PDU sets 455 and 460 in FIG. 4. Additionally, or alternatively, the second wireless communication device 510 may append dependency information to one or more PDUs associated with the one or more PDU sets. For example, the dependency information may be included in a header of at least one PDU associated with each PDU set. In some aspects, the dependency information may be included as part of ADU information included in the header of the at least one PDU associated with each PDU set.

In some aspects, the dependency information may include an indication of whether one or more PDUs associated with the PDU set is dependent on one or more other PDUs associated with another PDU set, and/or whether the PDU set is dependent on one or more other PDU sets. Put another way, in some aspects, the dependency information includes at least one of an indication of whether at least one PDU is dependent on one or more other PDUs, or an indication of whether a PDU set is dependent on one or more other PDU sets.

For example, in some aspects, a PDU set may be associated with an I-frame of a video compression process (e.g., a GOP video compression process), and thus the dependency information may indicate that the PDU set is not dependent on any other PDU sets because the I-frame may be independently encoded and decoded. However, in some other aspects, the PDU set may be associated with one of a P-frame or a B-frame of the video compression process. Thus, in such aspects, the dependency information may indicate that the PDU set is dependent on at least one other PDU set associated with a decompression process of the one of the P-frame or the B-frame, because P-frames and B-frames may use data from other frames (e.g., other I-frames, P-frames, and/or B-frames) during a decompression process.

Moreover, in some aspects, one or more PDUs may be associated with a coupled flow and/or a coupled delay deadline. Put another way, one or more PDUs may be a coupled PDU. For example, PDUs and/or PDU sets associated with video and audio streams in the same frame may be associated with a coupled flow such that the PDUs and/or PDU sets are delivered to a receiver at a same time to ensure a best user experience (e.g., to ensure aligned audio and video at the receiver). In such aspects, the dependency information may indicate that the PDU and/or the PDU set is dependent on (e.g., coupled to) another PDU and/or PDU set, because if one PDU and/or PDU set in one of the coupled flows becomes obsolete, then an associated PDU and/or PDU set in the other of the coupled flows also become obsolete. In some aspects, during an XR session establishment, a network device (e.g., the core network device 405 described in connection with FIG. 4) may configure a coupled flow identifier, which identifies that a set of flows are coupled. In such aspects, for each PDU transmitted, the second wireless communication device 510 may include, as part of ADU information or the like, the coupled flow identifier indicating with which flow a PDU is associated and/or indicating upon which other PDU and/or PDU set the PDU is dependent (e.g., coupled to).

As shown by reference number 520, in some aspects, the second wireless communication device 510 may perform a layer two PDU processing procedure associated with a PDU and/or a PDU set based at least in part on the dependency information. For example, in some aspects, the layer two PDU processing procedure may include performing a coupled discard procedure based at least in part on the dependency information. More particularly, the second wireless communication device 510 may discard one of at least one PDU or PDU set, and the layer two PDU processing procedure may include discarding one or more other PDUs or one or more other PDU sets that depend on the one of the at least one PDU or the PDU set based at least in part on discarding the one of the at least one PDU or the PDU set. In some aspects, the second wireless communication device 510 may discard the one of the at least one PDU or the PDU set (and thus any PDUs or PDU sets that depend on the one of the at least one PDU or the PDU set) based at least in part on an expiration of a PDCP reordering timer associated with a PDCP reordering process at the second wireless communication device 510. Additionally, or alternatively, the second wireless communication device 510 may discard the one of the at least one PDU or the PDU set (and thus any PDUs or PDU sets that depend on the one of the at least one PDU or the PDU set) based at least in part on an expiration of RLC reassembly timer associated with an RLC reassembly process at the second wireless communication device 510. Additionally, or alternatively, the second wireless communication device 510 may discard the one of the at least one PDU or the PDU set (and thus any PDUs or PDU sets that depend on the one of the at least one PDU or the PDU set) based at least in part on an expiration of a MAC hybrid automatic repeat request (HARQ) discard timer associated with a MAC HARQ process at the second wireless communication device 510.

In some aspects, the layer two PDU processing procedure may include performing a prioritized transmission of a PDU set based at least in part on the dependency information. More particularly, in some aspects, a first PDU set may be dependent on a second PDU set, such as a P-frame or a B-frame being dependent on a neighboring frame. Moreover, the first PDU set may be associated with a first transmission sequence number, and the second PDU set may be associated with a second transmission sequence number occurring later than the first transmission sequence number, which may indicate that the second PDU set is scheduled to be transmitted later in a sequence of transmissions than the first PDU set. Nonetheless, because, in this example, the dependency information may indicate that the first PDU set (e.g., the PDU set including the earlier transmission sequence number) is dependent on the second PDU set, the second wireless communication device 510 may schedule and/or transmit the second PDU set prior to the first PDU set. Put another way, in this aspect, the layer two PDU processing procedure may include reordering a sequence of transmissions such that a PDU set from which one or more other PDU sets are dependent on is transmitted before the one or more other PDU sets. In the example involving a GOP video compression process, when a PDU set associated with an I-frame is buffered together with one or more PDU sets associated with a P-frame and/or a B-frame that have earlier transmission sequence numbers, the PDU set associated with the I-frame may nonetheless be scheduled before the one or more PDU sets associated with the P-frame and/or the B-frame.

In some other aspects, the layer two PDU processing procedure may include performing a selective PDCP duplication process based at least in part on the dependency information. More particularly, in some aspects, a first PDU set may be dependent on a second PDU set, and no other PDU sets may be dependent on the first PDU set. In such aspects, the second PDU set may be duplicated according to a PDCP duplication process based at least in part on the first PDU set being dependent on the second PDU set, but the first PDU set may not be duplicated according to the PDCP duplication process based at least in part on no other PDU sets being dependent on the first PDU set. Returning to the example involving a GOP video compression process, if the network enables PDCP duplication, the network may configure whether only PDU sets associated with I-frames (and thus not PDU sets associated with P-frames and/or B-frames) are duplicated to ensure that the I-frames are safely received and thus available for decompression of subsequent, dependent frames (e.g., P-frames and/or B-frames).

In some aspects, the second wireless communication device 510 may transmit, and the first wireless communication device 505 may receive, an indication associated with the second wireless communication device 510 performing the layer two PDU processing procedure. For example, the second wireless communication device 510 may transmit a discard indication (sometimes referred to as a gap indication) indicating that the second wireless communication device 510 discarded one or more PDU sets, such as in accordance with the coupled discard procedure described above. More particularly, and as shown by reference number 525, in some aspects, the second wireless communication device 510 may transmit, to an RLC entity associated with the first wireless communication device 505, a discard indication that indicates one of the at least one PDU or a PDU set was discarded according to the layer two PDU processing procedure. The first wireless communication device 505 (e.g., the RLC entity associated with the first wireless communication device 505) may thus use this information when recreating a data stream, or the like.

As shown by reference numbers 530 and 535, the second wireless communication device 510 may transmit, and the first wireless communication device 505 may receive, multiple PDUs associated with PDU sets. For example, the second wireless communication device 510 may transmit to the first wireless communication device 505 multiple PDUs associated with a first PDU set (as shown by reference number 525), multiple PDUs associated with a second PDU set, as forth up to an N-th PDU set (as shown by reference number 530). As described above, at least one of the PDU sets may be dependent on another one of the PDU sets (e.g., at least one of the PDU sets may be associated with a P-frame or a B-frame that is dependent on another PDU set for a decompression process, at least one of the PDU sets is associated with a coupled flow and/or a coupled flow deadline with another PDU set, or the like). In some aspects, the PDU sets shown in connection with reference numbers 530 and 535 may be transmitted and received via a Uu interface (e.g., the PDU sets may be transmitted by one of a network node 110 or a UE 120 and received by the other one of the network node 110 and the UE 120). In some aspects, the PDU sets may include dependency information, such as the dependency information described above in connection with reference number 515. More particularly, for each PDU set transmitted, at least one PDU, of the multiple PDUs, may include dependency information associated with the PDU set. As described above in connection with reference number 515, in some aspects, the dependency information may include at least one of an indication of whether at least one PDU of the PDU set is dependent on one or more other PDUs, or an indication of whether the PDU set is dependent on one or more other PDU sets.

As shown by reference number 540, the first wireless communication device 505 may perform a layer two PDU processing procedure associated with at least one PDU or PDU set (e.g., associated with at least one PDU or PDU set received in connection with the communications described in connection with reference numbers 530 and 535) based at least in part on the dependency information. For example, in some aspects, the first wireless communication device 505 may discard a PDU and/or a PDU set at a PDCP entity associated with the first wireless communication device 505 and/or an RLC entity associated with the first wireless communication device 505 based at least in part on the dependency information. More particularly, in some aspects, the first wireless communication device 505 may discard one of at least one PDU or a PDU set, and the layer two PDU processing procedure may include discarding one or more other PDUs or one or more other PDU sets based at least in part on discarding the one of the at least one PDU or the PDU set because the dependency information indicates that the one or more other PDUs or the one or more other PDU sets depend on the discarded PDU and/or PDU set.

In some aspects, the first wireless communication device 505 may discard the one of the at least one PDU or the PDU set (and thus any PDUs or PDU sets that depend on the one of the at least one PDU or the PDU set) based at least in part on an expiration of a PDCP reordering timer associated with a PDCP reordering process at the first wireless communication device 505. Additionally, or alternatively, the first wireless communication device 505 may discard the one of the at least one PDU or the PDU set (and thus any PDUs or PDU sets that depend on the one of the at least one PDU or the PDU set) based at least in part on an expiration of an RLC reassembly timer. Additionally, or alternatively, the first wireless communication device 505 may discard the one of the at least one PDU or the PDU set (and thus any PDUs or PDU sets that depend on the one of the at least one PDU or the PDU set) based at least in part on an expiration of a MAC HARQ discard timer. For example, in aspects associated with a GOP video compression process or the like, when a Type A PDU set associated with an I-frame is discarded (because the Type A PDU set becomes obsolete after missing its deadline during a PDCP reordering operation, during a RLC reassembly operation, during a MAC HARQ retransmission, or the like), all PDUs in its dependent PDU sets may also be discarded.

In some aspects, the first wireless communication device 505 may perform a PDCP reordering procedure associated with a higher protocol layer than a physical layer (e.g., layer two and higher) based at least in part on the dependency information. Moreover, the first wireless communication device 505 may transmit a PDU set to the higher protocol layer after transmitting at least one other PDU set to the higher protocol layer based at least in part on the dependency information indicating that the PDU set is dependent on the one or more other PDU sets. For example, and returning to the GOP video compression process example, in some aspects, regardless of the delivery model configured for a DRB, a PDU set associated with a P-frame and/or a B-frame may not be delivered to a higher protocol layer by the first wireless communication device 505 if a PDU set associated with an I-frame, on which the PDU set associated with the P-frame and/or the B-frame depends, has not yet been received by the first wireless communication device 505.

In some aspects, the first wireless communication device 505 may transmit, and the second wireless communication device 510 may receive, an indication associated with the first wireless communication device 505 performing the layer two PDU processing procedure. For example, the first wireless communication device 505 may transmit a discard indication indicating that the first wireless communication device 505 discarded one or more PDU sets, such as in accordance with the PDCP and/or RLC discard procedure described above. More particularly, and as shown by reference number 545, in some aspects, the first wireless communication device 505 may transmit, to the second wireless communication device 510, a discard indication that indicates one of at least one PDU or a PDU set was discarded according to the layer two PDU processing procedure, in a similar manner as described in connection with the discard indication shown by reference number 525.

Based at least in part on a wireless communication device 505, 510 (e.g., a network node 110 or a UE 120) performing a layer two PDU processing procedure for a PDU set based at least in part on dependency information associated with the PDU set, the wireless communication device 505, 510 may conserve computing, power, network, and/or communication resources that may have otherwise been consumed performing a traditional layer two PDU processing procedure (e.g., by performing a layer two PDU processing procedure without considering whether the PDU set or a PDU thereof is dependent on another PDU set and/or another PDU). For example, based at least in part on the wireless communication device 505, 510 performing a layer two PDU processing procedure for a PDU set based at least in part on dependency information associated with the PDU set, the wireless communication device 505, 510 may conserve computing, power, network, and/or communication resources that may have otherwise been consumed to transmit and process obsolete and/or redundant PDUs and/or PDU sets.

As indicated above, FIG. 5 is provided as an example. Other examples may differ from what is described with respect to FIG. 5.

FIG. 6 is a diagram illustrating an example process 600 performed, for example, by a wireless communication device, in accordance with the present disclosure. Example process 600 is an example where the wireless communication device (e.g., first wireless communication device 505) performs operations associated with layer two processing procedures for PDU sets with dependency.

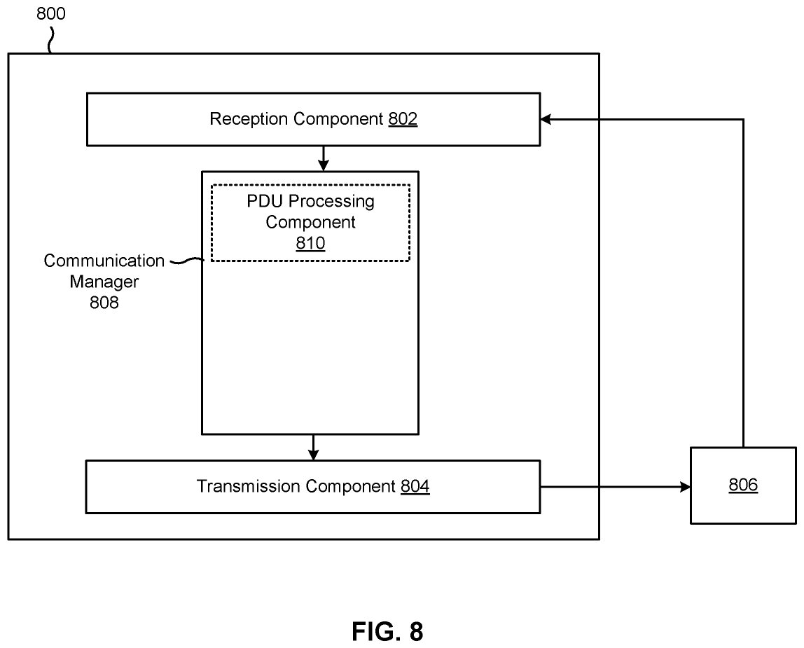

As shown in FIG. 6, in some aspects, process 600 may include receiving multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets (block 610). For example, the wireless communication device (e.g., using communication manager 808 and/or reception component 802, depicted in FIG. 8) may receive multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets, as described above.

As further shown in FIG. 6, in some aspects, process 600 may include performing a layer two PDU processing procedure associated with the at least one PDU or the PDU set based at least in part on the dependency information (block 620). For example, the wireless communication device (e.g., using communication manager 808, and/or PDU processing component 810, depicted in FIG. 8) may perform a layer two PDU processing procedure associated with the at least one PDU or the PDU set based at least in part on the dependency information, as described above.

Process 600 may include additional aspects, such as any single aspect or any combination of aspects described below and/or in connection with one or more other processes described elsewhere herein.

In a first aspect, the PDU set is associated with an intra-coded frame of a video compression process, and the dependency information indicates that the PDU set is not dependent on any other PDU sets.

In a second aspect, alone or in combination with the first aspect, the PDU set is associated with one of a P-frame or a B-frame of a video compression process, and the dependency information indicates that the PDU set is dependent on at least one other PDU set associated with a decompression process of the one of the P-frame or the B-frame.

In a third aspect, alone or in combination with one or more of the first and second aspects, the dependency information is included in a header of the at least one PDU.

In a fourth aspect, alone or in combination with one or more of the first through third aspects, the at least one PDU is received via a Uu interface.

In a fifth aspect, alone or in combination with one or more of the first through fourth aspects, process 600 includes discarding one of the at least one PDU or the PDU set, wherein the layer two PDU processing procedure includes discarding the one or more other PDUs or the one or more other PDU sets based at least in part on discarding the one of the at least one PDU or the PDU set.

In a sixth aspect, alone or in combination with one or more of the first through fifth aspects, discarding the one of the at least one PDU or the PDU set is based at least in part on at least one of an expiration of a packet data convergence protocol reordering timer, an expiration of a radio link control reassembly timer, or an expiration of a medium access control hybrid automatic repeat request discard timer.

In a seventh aspect, alone or in combination with one or more of the first through sixth aspects, process 600 includes transmitting a discard indication that indicates the one of the at least one PDU or the PDU set was discarded.

In an eighth aspect, alone or in combination with one or more of the first through seventh aspects, process 600 includes performing a PDCP reordering procedure associated with a higher protocol layer than a physical layer, and transmitting the PDU set to the higher protocol layer after transmitting at least one other PDU set to the higher protocol layer based at least in part on the dependency information indicating that the PDU set is dependent on the one or more other PDU sets.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a wireless communication device, in accordance with the present disclosure. Example process 700 is an example where the wireless communication device (e.g., second wireless communication device 510) performs operations associated with layer two processing procedures for PDU sets with dependency.

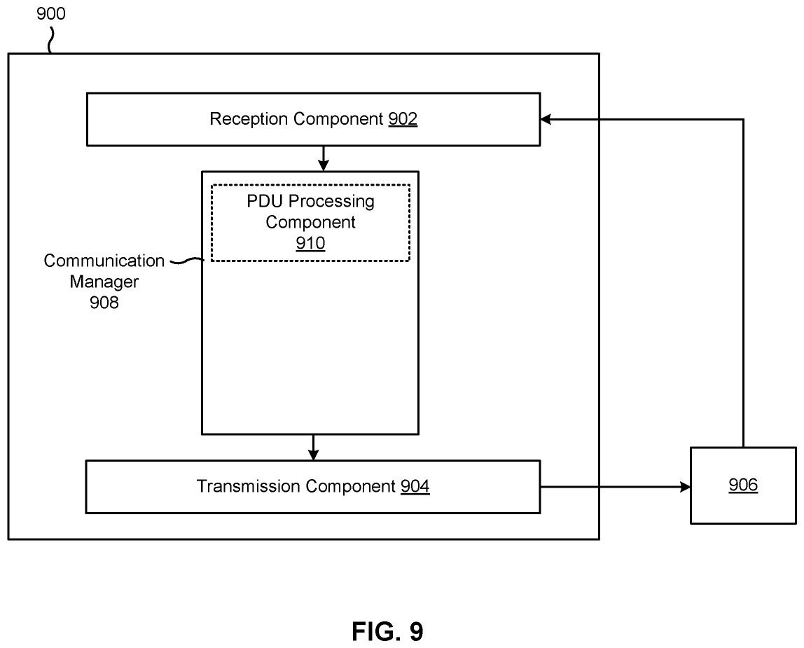

As shown in FIG. 7, in some aspects, process 700 may include transmitting multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets (block 710). For example, the wireless communication device (e.g., using communication manager 908 and/or transmission component 904, depicted in FIG. 9) may transmit multiple PDUs associated with a PDU set, wherein at least one PDU, of the multiple PDUs, includes dependency information associated with the PDU set, and wherein the dependency information includes at least one of: an indication of whether the at least one PDU is dependent on one or more other PDUs, or an indication of whether the PDU set is dependent on one or more other PDU sets, as described above.

As further shown in FIG. 7, in some aspects, process 700 may include performing a layer two PDU processing procedure associated with the at least one PDU or the PDU set based at least in part on the dependency information (block 720). For example, the wireless communication device (e.g., using communication manager 908 and/or PDU processing component 910, depicted in FIG. 9) may perform a layer two PDU processing procedure associated with the at least one PDU or the PDU set based at least in part on the dependency information, as described above.

Process 700 may include additional aspects, such as any single aspect or any combination of aspects described below and/or in connection with one or more other processes described elsewhere herein.

In a first aspect, the PDU set is associated with an intra-coded frame of a video compression process, and the dependency information indicates that the PDU set is not dependent on any other PDU sets.

In a second aspect, alone or in combination with the first aspect, the PDU set is associated with one of a P-frame or B-frame of a video compression process, and the dependency information indicates that the PDU set is dependent on at least one other PDU set associated with a decompression process of the one of the P-frame or the B-frame.

In a third aspect, alone or in combination with one or more of the first and second aspects, the dependency information is included in a header of the at least one PDU.

In a fourth aspect, alone or in combination with one or more of the first through third aspects, the at least one PDU is transmitted via a Uu interface.

In a fifth aspect, alone or in combination with one or more of the first through fourth aspects, process 700 includes discarding one of the at least one PDU or the PDU set, wherein the layer two PDU processing procedure includes discarding the one or more other PDUs or the one or more other PDU sets based at least in part on discarding the one of the at least one PDU or the PDU set.

In a sixth aspect, alone or in combination with one or more of the first through fifth aspects, discarding the one of the at least one PDU or the PDU set is based at least in part on at least one of an expiration of a packet data convergence protocol reordering timer, an expiration of a radio link control reassembly timer, or an expiration of a medium access control hybrid automatic repeat request discard timer.

In a seventh aspect, alone or in combination with one or more of the first through sixth aspects, process 700 includes transmitting, to a radio link control entity associated with another wireless communication device, a discard indication that indicates the one of the at least one PDU or the PDU set was discarded.

In an eighth aspect, alone or in combination with one or more of the first through seventh aspects, the PDU set is dependent on another PDU set, the PDU set is associated with a first transmission sequence number, the other PDU set is associated with a second transmission sequence number occurring later than the first transmission sequence number, and the other PDU set is transmitted prior to the PDU set based at least in part on the PDU set being dependent on the other PDU set.

In a ninth aspect, alone or in combination with one or more of the first through eighth aspects, the PDU set is dependent on another PDU set, no other PDU sets are dependent on the PDU set, the other PDU set is duplicated according to a PDCP duplication process based at least in part on the PDU set being dependent on the other PDU set, and the PDU set is not duplicated according to the PDCP duplication process based at least in part on no other PDU sets being dependent on the PDU set.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a wireless communication device (e.g., the first wireless communication device 505), or a wireless communication device may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE 120, a network node 110, or another wireless communication device, such as the second wireless communication device 510) using the reception component 802 and the transmission component 804. As further shown, the apparatus 800 may include the communication manager 808 (e.g., communication manager 140 and/or communication manager 150). The communication manager 808 may include a PDU processing component 810, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE 120 and/or network node 110 described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE 120 and/or the network node 110 described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE 120 and/or the network node 110 described in connection with FIG. 2. In some aspects, the transmission component 804 may be co-located with the reception component 802 in a transceiver.

The reception component 802 may receive multiple PDUs associated with a PDU set, wherein at least one PDU, of the multiple PDUs, includes dependency information associated with the PDU set, wherein the dependency information includes at least one of an indication of whether the at least one PDU is dependent on one or more other PDUs, or an indication of whether the PDU set is dependent on one or more other PDU sets. The PDU processing component 810 may perform a layer two PDU processing procedure associated with the at least one PDU or the PDU set based at least in part on the dependency information.

The PDU processing component 810 may discard one of the at least one PDU or the PDU set, wherein the layer two PDU processing procedure includes discarding the one or more other PDUs or the one or more other PDU sets based at least in part on discarding the one of the at least one PDU or the PDU set.

The transmission component 804 may transmit a discard indication that indicates the one of the at least one PDU or the PDU set was discarded.

The PDU processing component 810 may perform a PDCP reordering procedure associated with a higher protocol layer than a physical layer.

The transmission component 804 and/or the PDU processing component 810 may transmit the PDU set to the higher protocol layer after transmitting at least one other PDU set to the higher protocol layer based at least in part on the dependency information indicating that the PDU set is dependent on the one or more other PDU sets.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a wireless communication device (e.g., the second wireless communication device 510), or a wireless communication device may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE 120, a network node 110, or another wireless communication device, such as the first wireless communication device 505) using the reception component 902 and the transmission component 904. As further shown, the apparatus 900 may include the communication manager 908 (e.g., communication manager 140 and/or communication manager 150). The communication manager 908 may include a PDU processing component 910, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE 120 and/or the network node 110 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE 120 and/or the network node 110 described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE 120 and/or the network node 110 described in connection with FIG. 2. In some aspects, the transmission component 904 may be co-located with the reception component 902 in a transceiver.

The transmission component 904 may transmit multiple PDUs associated with a PDU set, wherein at least one PDU, of the multiple PDUs, includes dependency information associated with the PDU set, wherein the dependency information includes at least one of an indication of whether the at least one PDU is dependent on one or more other PDUs, or an indication of whether the PDU set is dependent on one or more other PDU sets. The PDU processing component 910 may perform a layer two PDU processing procedure associated with the at least one PDU or the PDU set based at least in part on the dependency information.

The PDU processing component 910 may discard one of the at least one PDU or the PDU set, wherein the layer two PDU processing procedure includes discarding the one or more other PDUs or the one or more other PDU sets based at least in part on discarding the one of the at least one PDU or the PDU set.

The transmission component 904 may transmit, to a radio link control entity associated with another wireless communication device, a discard indication that indicates the one of the at least one PDU or the PDU set was discarded.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a wireless communication device, comprising: receiving multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and performing a layer two PDU processing procedure associated with the at least one PDU or the PDU set based at least in part on the dependency information.

Aspect 2: The method of Aspect 1, wherein the PDU set is associated with an intra-coded frame of a video compression process, and wherein the dependency information indicates that the PDU set is not dependent on any other PDU sets.

Aspect 3: The method of Aspect 1, wherein the PDU set is associated with one of a P-frame or a B-frame of a video compression process, and wherein the dependency information indicates that the PDU set is dependent on at least one other PDU set associated with a decompression process of the one of the P-frame or the B-frame.

Aspect 4: The method of any of Aspects 1-3, wherein the dependency information is included in a header of the at least one PDU.

Aspect 5: The method of any of Aspects 1-4, wherein the at least one PDU is received via a Uu interface.

Aspect 6: The method of any of Aspects 1-5, further comprising discarding one of the at least one PDU or the PDU set, wherein the layer two PDU processing procedure includes discarding the one or more other PDUs or the one or more other PDU sets based at least in part on discarding the one of the at least one PDU or the PDU set.

Aspect 7: The method of Aspect 6, wherein discarding the one of the at least one PDU or the PDU set is based at least in part on at least one of: an expiration of a packet data convergence protocol reordering timer, an expiration of a radio link control reassembly timer, or an expiration of a medium access control hybrid automatic repeat request discard timer.

Aspect 8: The method of any of Aspects 6-7, further comprising transmitting a discard indication that indicates the one of the at least one PDU or the PDU set was discarded.

Aspect 9: The method of any of Aspects 1-8, further comprising: performing a PDCP reordering procedure associated with a higher protocol layer than a physical layer; and transmitting the PDU set to the higher protocol layer after transmitting at least one other PDU set to the higher protocol layer based at least in part on the dependency information indicating that the PDU set is dependent on the one or more other PDU sets.

Aspect 10: A method of wireless communication performed by a wireless communication device, comprising: transmitting multiple PDUs associated with a PDU set, wherein at least one PDU, of the multiple PDUs, includes dependency information associated with the PDU set, wherein the dependency information includes at least one of: an indication of whether the at least one PDU is dependent on one or more other PDUs, or an indication of whether the PDU set is dependent on one or more other PDU sets; and performing a layer two PDU processing procedure associated with the at least one PDU or the PDU set based at least in part on the dependency information.

Aspect 11: The method of Aspect 10, wherein the PDU set is associated with an intra-coded frame of a video compression process, and wherein the dependency information indicates that the PDU set is not dependent on any other PDU sets.

Aspect 12: The method of Aspect 10, wherein the PDU set is associated with one of a P-frame or a B-frame of a video compression process, and wherein the dependency information indicates that the PDU set is dependent on at least one other PDU set associated with a decompression process of the one of the P-frame or the B-frame.

Aspect 13: The method of any of Aspects 10-12, wherein the dependency information is included in a header of the at least one PDU.

Aspect 14: The method of any of Aspects 10-13, wherein the at least one PDU is transmitted via a Uu interface.

Aspect 15: The method of any of Aspects 10-14, further comprising discarding one of the at least one PDU or the PDU set, wherein the layer two PDU processing procedure includes discarding the one or more other PDUs or the one or more other PDU sets based at least in part on discarding the one of the at least one PDU or the PDU set.

Aspect 16: The method of Aspect 15, wherein discarding the one of the at least one PDU or the PDU set is based at least in part on at least one of: an expiration of a packet data convergence protocol reordering timer, an expiration of a radio link control reassembly timer, or an expiration of a medium access control hybrid automatic repeat request discard timer.

Aspect 17: The method of any of Aspects 15-16, further comprising transmitting, to a radio link control entity associated with another wireless communication device, a discard indication that indicates the one of the at least one PDU or the PDU set was discarded.

Aspect 18: The method of any of Aspects 10-17, wherein the PDU set is dependent on another PDU set, wherein the PDU set is associated with a first transmission sequence number, wherein the other PDU set is associated with a second transmission sequence number occurring later than the first transmission sequence number, and wherein the other PDU set is transmitted prior to the PDU set based at least in part on the PDU set being dependent on the other PDU set.

Aspect 19: The method of any of Aspects 10-18, wherein the PDU set is dependent on another PDU set, wherein no other PDU sets are dependent on the PDU set, wherein the other PDU set is duplicated according to a PDCP duplication process based at least in part on the PDU set being dependent on the other PDU set, and wherein the PDU set is not duplicated according to the PDCP duplication process based at least in part on no other PDU sets being dependent on the PDU set.

Aspect 20: An apparatus for wireless communication at a device, comprising a processor; memory coupled with the processor; and instructions stored in the memory and executable by the processor to cause the apparatus to perform the method of one or more of Aspects 1-9.

Aspect 21: A device for wireless communication, comprising a memory and one or more processors coupled to the memory, the one or more processors configured to perform the method of one or more of Aspects 1-9.

Aspect 22: An apparatus for wireless communication, comprising at least one means for performing the method of one or more of Aspects 1-9.

Aspect 23: A non-transitory computer-readable medium storing code for wireless communication, the code comprising instructions executable by a processor to perform the method of one or more of Aspects 1-9.

Aspect 24: A non-transitory computer-readable medium storing a set of instructions for wireless communication, the set of instructions comprising one or more instructions that, when executed by one or more processors of a device, cause the device to perform the method of one or more of Aspects 1-9.

Aspect 25: An apparatus for wireless communication at a device, comprising a processor; memory coupled with the processor; and instructions stored in the memory and executable by the processor to cause the apparatus to perform the method of one or more of Aspects 10-19.

Aspect 26: A device for wireless communication, comprising a memory and one or more processors coupled to the memory, the one or more processors configured to perform the method of one or more of Aspects 10-19.

Aspect 27: An apparatus for wireless communication, comprising at least one means for performing the method of one or more of Aspects 10-19.

Aspect 28: A non-transitory computer-readable medium storing code for wireless communication, the code comprising instructions executable by a processor to perform the method of one or more of Aspects 10-19.

Aspect 29: A non-transitory computer-readable medium storing a set of instructions for wireless communication, the set of instructions comprising one or more instructions that, when executed by one or more processors of a device, cause the device to perform the method of one or more of Aspects 10-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a memory; and
one or more processors, coupled to the memory, configured to:
receive multiple protocol data units (PDUs) associated with a PDU set, wherein at least one PDU, of the multiple PDUs, includes dependency information associated with the PDU set, wherein the dependency information includes at least one of:
an indication of whether the at least one PDU is dependent on one or more other PDUs, or
an indication of whether the PDU set is dependent on one or more other PDU sets; and
perform a layer two PDU processing procedure associated with the at least one PDU or the PDU set based at least in part on the dependency information.

2. The wireless communication device of claim 1, wherein the PDU set is associated with an intra-coded frame of a video compression process, and wherein the dependency information indicates that the PDU set is not dependent on any other PDU sets.

3. The wireless communication device of claim 1, wherein the PDU set is associated with one of a predicted frame (P-frame) or a bidirectional predicted frame (B-frame) of a video compression process, and wherein the dependency information indicates that the PDU set is dependent on at least one other PDU set associated with a decompression process of the one of the P-frame or the B-frame.

4. The wireless communication device of claim 1, wherein the dependency information is included in a header of the at least one PDU.

5. The wireless communication device of claim 1, wherein the at least one PDU is received via a Uu interface.

6. The wireless communication device of claim 1, wherein the one or more processors are further configured to discard one of the at least one PDU or the PDU set, wherein the layer two PDU processing procedure includes discarding the one or more other PDUs or the one or more other PDU sets based at least in part on discarding the one of the at least one PDU or the PDU set.

7. The wireless communication device of claim 6, wherein discarding the one of the at least one PDU or the PDU set is based at least in part on at least one of:
an expiration of a packet data convergence protocol reordering timer,
an expiration of a radio link control reassembly timer, or
an expiration of a medium access control hybrid automatic repeat request discard timer.

8. The wireless communication device of claim 6, wherein the one or more processors are further configured to transmit a discard indication that indicates the one of the at least one PDU or the PDU set was discarded.

9. The wireless communication device of claim 1, wherein the one or more processors are further configured to:
perform a packet data convergence protocol (PDCP) reordering procedure associated with a higher protocol layer than a physical layer; and
transmit the PDU set to the higher protocol layer after transmitting at least one other PDU set to the higher protocol layer based at least in part on the dependency information indicating that the PDU set is dependent on the one or more other PDU sets.

10. A wireless communication device for wireless communication, comprising:
a memory; and
one or more processors, coupled to the memory, configured to:
transmit multiple protocol data units (PDUs) associated with a PDU set, wherein at least one PDU, of the multiple PDUs, includes dependency information associated with the PDU set, wherein the dependency information includes at least one of:
an indication of whether the at least one PDU is dependent on one or more other PDUs, or
an indication of whether the PDU set is dependent on one or more other PDU sets; and
perform a layer two PDU processing procedure associated with the at least one PDU or the PDU set based at least in part on the dependency information.

11. The wireless communication device of claim 10, wherein the PDU set is associated with an intra-coded frame of a video compression process, and wherein the dependency information indicates that the PDU set is not dependent on any other PDU sets.

12. The wireless communication device of claim 10, wherein the PDU set is associated with one of a predicted frame (P-frame) or a bidirectional predicted frame (B-frame) of a video compression process, and wherein the dependency information indicates that the PDU set is dependent on at least one other PDU set associated with a decompression process of the one of the P-frame or the B-frame.

13. The wireless communication device of claim 10, wherein the dependency information is included in a header of the at least one PDU.

14. The wireless communication device of claim 10, wherein the at least one PDU is transmitted via a Uu interface.

15. The wireless communication device of claim 10, wherein the one or more processors are further configured to discard one of the at least one PDU or the PDU set, wherein the layer two PDU processing procedure includes discarding the one or more other PDUs or the one or more other PDU sets based at least in part on discarding the one of the at least one PDU or the PDU set.

16. The wireless communication device of claim 15, wherein discarding the one of the at least one PDU or the PDU set is based at least in part on at least one of:
an expiration of a packet data convergence protocol reordering timer,
an expiration of a radio link control reassembly timer, or
an expiration of a medium access control hybrid automatic repeat request discard timer.

17. The wireless communication device of claim 15, wherein the one or more processors are further configured to transmit, to a radio link control entity associated with another wireless communication device, a discard indication that indicates the one of the at least one PDU or the PDU set was discarded.

18. The wireless communication device of claim 10, wherein the PDU set is dependent on another PDU set, wherein the PDU set is associated with a first transmission sequence number, wherein the other PDU set is associated with a second transmission sequence number occurring later than the first transmission sequence number, and wherein the other PDU set is transmitted prior to the PDU set based at least in part on the PDU set being dependent on the other PDU set.

19. The wireless communication device of claim 10, wherein the PDU set is dependent on another PDU set, wherein no other PDU sets are dependent on the PDU set, wherein the other PDU set is duplicated according to a packet data convergence protocol (PDCP) duplication process based at least in part on the PDU set being dependent on the other PDU set, and wherein the PDU set is not duplicated according to the PDCP duplication process based at least in part on no other PDU sets being dependent on the PDU set.

20. A method of wireless communication performed by a wireless communication device, comprising:
receiving multiple protocol data units (PDUs) associated with a PDU set, wherein at least one PDU, of the multiple PDUs, includes dependency information associated with the PDU set, wherein the dependency information includes at least one of:
an indication of whether the at least one PDU is dependent on one or more other PDUs, or
an indication of whether the PDU set is dependent on one or more other PDU sets; and
performing a layer two PDU processing procedure associated with the at least one PDU or the PDU set based at least in part on the dependency information.

21. The method of claim 20, wherein the PDU set is associated with an intra-coded frame of a video compression process, and wherein the dependency information indicates that the PDU set is not dependent on any other PDU sets.

22. The method of claim 20, wherein the PDU set is associated with one of a predicted frame (P-frame) or a bidirectional predicted frame (B-frame) of a video compression process, and wherein the dependency information indicates that the PDU set is dependent on at least one other PDU set associated with a decompression process of the one of the P-frame or the B-frame.

23. The method of claim 20, wherein the dependency information is included in a header of the at least one PDU.

24. The method of claim 20, further comprising discarding one of the at least one PDU or the PDU set, wherein the layer two PDU processing procedure includes discarding the one or more other PDUs or the one or more other PDU sets based at least in part on discarding the one of the at least one PDU or the PDU set.

25. The method of claim 24, wherein discarding the one of the at least one PDU or the PDU set is based at least in part on at least one of:
an expiration of a packet data convergence protocol reordering timer,
an expiration of a radio link control reassembly timer, or
an expiration of a medium access control hybrid automatic repeat request discard timer.

26. A method of wireless communication performed by a wireless communication device, comprising:
transmitting multiple protocol data units (PDUs) associated with a PDU set, wherein at least one PDU, of the multiple PDUs, includes dependency information associated with the PDU set, wherein the dependency information includes at least one of:
an indication of whether the at least one PDU is dependent on one or more other PDUs, or
an indication of whether the PDU set is dependent on one or more other PDU sets; and
performing a layer two PDU processing procedure associated with the at least one PDU or the PDU set based at least in part on the dependency information.

27. The method of claim 26, wherein the PDU set is associated with an intra-coded frame of a video compression process, and wherein the dependency information indicates that the PDU set is not dependent on any other PDU sets.

28. The method of claim 26, wherein the PDU set is associated with one of a predicted frame (P-frame) or a bidirectional predicted frame (B-frame) of a video compression process, and wherein the dependency information indicates that the PDU set is dependent on at least one other PDU set associated with a decompression process of the one of the P-frame or the B-frame.

29. The method of claim 26, wherein the dependency information is included in a header of the at least one PDU.

30. The method of claim 26, further comprising discarding one of the at least one PDU or the PDU set, wherein the layer two PDU processing procedure includes discarding the one or more other PDUs or the one or more other PDU sets based at least in part on discarding the one of the at least one PDU or the PDU set.
